(19) United States
(12) Patent Application Publication
(10) Pub. No.: US 2019/0246609 A1
(43) Pub. Date: Aug. 15, 2019

(54) POULTRY CONTAINER COVER, POULTRY CONTAINER, AND POULTRY CONTAINER ASSEMBLY FOR HOLDING LIVE POULTRY

(71) Applicant: MAREL STORK POULTRY PROCESSING B.V., Boxmeer (NL)

(72) Inventors: Jeroen VERGELDT, Well (NL); Marcus Marinus Gerardus KROOT, Sint Anthonis (NL); Roger Pierre Hubertus Maria CLAESSENS, Malden (NL)

(21) Appl. No.: 16/345,841

(22) PCT Filed: Oct. 25, 2017
(86) PCT No.: PCT/NL2017/050697

§ 371 Date: Apr. 29, 2019

(30) Foreign Application Priority Data
Nov. 2, 2016 (NL) 2017706

(51) Int. Cl. A01K 31/00; A01K 45/00

(52) U.S. Cl. CPC A01K 31/002; A01K 31/07; A01K 45/005

(57) ABSTRACT

The present invention relates to a cover for a poultry container for holding live poultry, comprising: two substantially parallel guides; plural longitudinal supports, on opposite sides moveable connected to the guides; a flexible cover sheet, connected to the longitudinal supports; wherein the parallel guides are provided with preferred holding locations for preferred positioning of the longitudinal supports onto the guides. The invention also relates to a poultry container including such a cover as well as to a poultry container assembly of plural stacked poultry containers.

The present invention relates to a poultry container cover to screen off a poultry container for holding live poultry, to a poultry container for holding live poultry comprising a poultry container cover, as well as to a poultry container assembly for holding live poultry comprising a stack of poultry containers with a poultry container including a poultry container cover placed on top.

During storage and transport of poultry (for instance on a poultry farm, from a poultry farm to another poultry farm, on a transport vehicle, from a poultry farm to a slaughterhouse or on a slaughterhouse) the poultry is usually held or transported alive in poultry holders. One such poultry holder is normally designed to hold plural animals in the order of magnitude of a dozen or several dozen of animals. These poultry holders are also referred to as “pallets”, “crates”, “cages” or “containers”. For easy logistics a plurality of such poultry holders may be combined in a shared support structure that makes it possible to stack the poultry holders compact and to displace a support structure with the several holders as a single unit. A support structure may consist of a steel frame in which a number of poultry holders are held in stacked (multilayer) manner and from which the poultry holders can be wholly or partially removed, and can thus for instance be embodied such that they can slide optionally fully into and out of the support structure, similarly to drawers in a chest of drawers. Another possibility is to integrate the poultry containers with the support structure so that this latter comprises compartments provided with individually controllable closing means.

As an alternative also plural individual poultry containers may be used that may be stacked onto each other to be combined to a poultry container assembly of a desired height. In practise use may be made of poultry containers assemblies with stacks of for instance four, five or six poultry containers stacked onto each other. Each poultry container containing live poultry of a poultry container assembly is covered by the poultry container placed on top of that poultry container except for the upper most poultry container of the poultry container assembly.

It is an object of the present invention to provide an efficient and effective poultry container cover for a poultry container for holding live poultry to shield off a top poultry container, as well as a poultry container including such a cover. A further object of the present invention is to support the flexibility in the storage and transportation of live poultry.

The invention provides for this purpose a cover for a poultry container for holding live poultry, comprising: two substantially parallel guides; plural longitudinal supports, on opposite sides moveable connected to the guides; and a flexible cover sheet, connected to the longitudinal supports; wherein the parallel guides are provided with preferred holding locations for preferred positioning of the longitudinal supports onto the guides.

Such a poultry container cover enables controlled opening and closure of the poultry container cover combined with a simple, solid and compact construction of the closure. By moving the longitudinal supports along the guides the flexible cover sheet may be brought in a position wherein the flexible cover sheet substantially closes off the space (surface area) between the guides, or—in other words—prevents poultry to pass the space between the guides. In the situation a poultry container is at least partially filled with poultry by closing the cover the uncontrolled removal of poultry from the poultry container may be prevented by closing the poultry container cover according to the present invention. Thus for instance during transport of the poultry container the cover will be closed, and at the location where the poultry is to be processed further the cover may be opened (or at a location where poultry is to be loaded into a poultry container) by moving the longitudinal supports more towards each other. By moving the longitudinal supports towards each other the flexible cover sheet will also be moved such that is covers a smaller part of the space (surface area) between the guides. Dependent on the relative movement of the longitudinal supports a smaller or larger part of the space between the guides will not be covered anymore by the flexible cover sheet and thus a poultry container provided with the poultry container cover may be filled with, or discharged of, poultry. Various process wherein the poultry container is used (e.g. loading, transporting, unloading, cleaning, storage and so on) may require different orientation of the longitudinal supports relative to the guides. The poultry container cover according to the present invention has het advantage that is enables opening the cover from two opposite sides and that it enables opening of the poultry container cover to a large extend, that is to say for far more than 50% of the area that may be screened by the poultry container cover.

As to assist the operator in simple and correct positioning of the longitudinal supports onto the guides the parallel guides are provided with preferred holding locations for preferred positioning of the longitudinal supports onto the guides. This implies that there is a “feedback” (e.g. a tactile barrier) for an operator (or a feed back to a mechanical system) when moving one or more longitudinal supports to a desired location onto the guides. For instance preferred holding locations for “fully opened”, “intermediate opened”, and/or “fully closed” may be provided to simplify the correct positioning of the longitudinal supports, and thus of the flexible cover sheet. A further advantage of the poultry container cover according to the present invention is that the longitudinal supports are slideable and that the cover thus may be opened and closed without the requirement of substantial space above the poultry container cover (as the opening and/or closing takes place more or less in a single plane).

The preferred holding locations of the guides of the poultry container cover according to the present invention may be defined with relief on the guides, like for instance ridges, bumps, chamfers and/or bevels. As an alternative—or additionally to the relief on the guides—the preferred holding locations of the guides may be defined with magnetic force, like for instance co-operating magnetic elements in guides and the longitudinal supports. The advantage of defined holding locations of the longitudinal supports on the guides enables simpler use of the cover. For instance in opening or closing a preferred position of one or more of the longitudinal supports guarantees that the intended use may be realised. In closing the poultry container cover it is preferred to be sure that the longitudinal supports are in the “closed position”, which is a situation wherein complete space (surface area) between the guides is blocked for the passage of poultry. In this situation the longitudinal supports have to be spreaded out over the length of the guides. In opening the poultry container cover (from one side or from two opposite sides) the longitudinal supports have to be brought in a closers configuration to be sure the poultry container cover is opened enough to provide satisfactory access to the interior of a poultry container. The provision of defined holding locations ensures more user-friendliness and less chance of problems during use of the poultry container covers.

It is also possible that one or more longitudinal supports are not moveable relative to the guides, for instance a central longitudinal support may be connected fixed (immoveable) to the guides so to provide a central fixed position enabling for instance the other longitudinal supports to be moved to an (dual) opened position wherein all the longitudinal supports from two opposite sides are displaced (shifted) towards the fixed central longitudinal support. As an alternative also one of the outer longitudinal supports may be connected fixed (immoveable) to the guides, providing a cover that is openly to be opened from one side.

The flexible cover sheet may be provided with openings, like for instance a (synthetic) sheet with apertures, or a net like a wire mesh structure. The advantage of openings in the cover sheet is that the cover sheet enables ventilation of live poultry held by a poultry container that is covered with the poultry container cover according to the present invention.

Furthermore the guides may be provided with couplings for connecting the guides onto a poultry container. Such coupling enable the easy assembly (and disassembly) of a poultry container and the poultry container cover according to the present invention.

The invention also provides a poultry container for holding live poultry, comprising: a bottom wall, four side walls protruding from the bottom wall and a cover for a poultry container according to the present invention, which poultry container cover is connected to the side walls at distance from the bottom wall. With the poultry container cover the poultry container may be screen off but also may be made accessible. The preferred holding locations of the poultry container cover are located on the parallel guides at least on positions adjoining two opposite side walls of the poultry container and at one or more positions centrally between two opposite walls. This enables longitudinal supports to be located close to the opposite side walls and thus to make the cover sheet to prevent poultry to leave or enter the poultry container in the situation the poultry container cover is closed. The poultry container cover may be opened from one side or from two opposite sides, dependent which longitudinal supports are moveable connected to the guides. The poultry container including the poultry container cover may be used individually for the logistic handling of poultry but normally such poultry container will be used as the top poultry container of a stack of plural poultry containers, which will be explained in more detail later.

The poultry container may be provided with a door, which door is formed by a section of one of the side walls and a, with the side wall section connected, section of the bottom wall, which door is moveable connected with the rest of the poultry container such that the door is displaceable between a position wherein the door fits the rest of the poultry container and a position wherein the door leaves an opening in the side wall and the bottom for the passage of poultry. In the situation wherein the poultry container cover is at least partially opened the door is accessible and may be used to get access to a location underneath the poultry container. The door may be centrally located in the side wall wherein the door is installed to keep the guides away from the working area of the door. To prevent further undesired interaction of the poultry container cover and the door the door may be slideable connected with the rest of the bottom wall.

The invention also provides a poultry container assembly for holding live poultry, comprising plural stacked poultry containers including a poultry container with a poultry container cover according to the present invention placed on top of the stack of poultry containers. The poultry containers may be stacked by placing a poultry container on top of an underlying poultry container such that the underlying poultry container is closed by the poultry container that is placed on top of it. The assembly may also include a poultry container base that differs in construction of the poultry containers as it has to fulfil different functions than the poultry containers stacked on top of it. Preferably the poultry container base is for instance also provided of sockets for housing the fork of a fork-lift truck.

As mentioned before the top poultry container includes the poultry container cover according to the invention to shield off the top poultry container. In practise often use will be made of a poultry container base, on top of which subsequently four (or five) poultry containers are placed with the top poultry containers including the poultry container cover. However also larger or smaller assemblies may be applied, as desired including or excluding a poultry container base. Variation in the height/capacity of the assembly enables to adapt the poultry container assembly to actual circumstances. It is even possible to put together an assembly of a poultry container base on which base are one or more poultry containers stacked where upon again a poultry container base is stacked on top of which one or more subsequent poultry containers may be stacked of which the upper most poultry container including the poultry container cover. For instance a practical stack-size for loading or unloading may be a base with four poultry containers while a transport facility (e.g. a truck) may allow to pile up two of such “five layered” assembles to result in a “ten layered” transport assembly configuration wherein the fifth poultry container element includes a poultry container cover and the tenth poultry container element includes a poultry container cover. Such configuration enable de-stacking of the ten layered assembly to two five layered assemblies, wherein both the top poultry containers of the two five layered assemblies are provided with a covered top poultry container. To provide this functionality the poultry container cover may be located below the upper side of the side walls protruding from the bottom wall of the poultry container, so that stacking a poultry container (or a poultry container basis) on a poultry container including a poultry container cover is possible without substantial weight being exerted on the poultry container cover.

The invention will be further elucidated herein below on the basis of the non-limitative exemplary embodiments shown in the following figures. Herein:

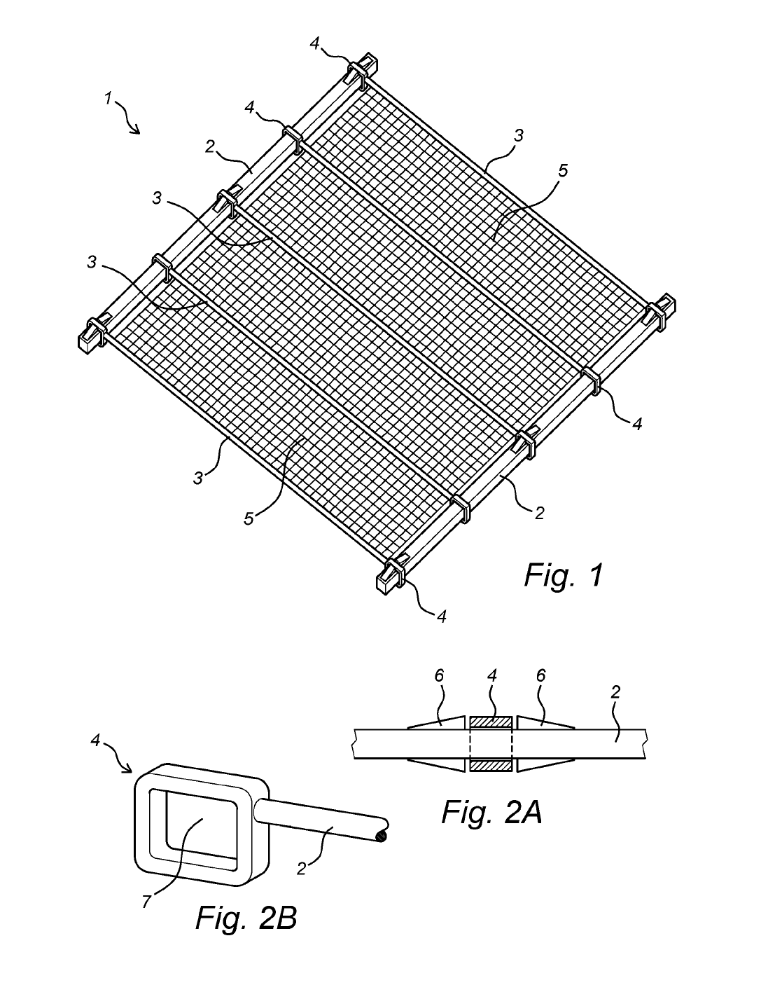

FIG. 1 shows a perspective schematic view of a poultry container cover according to the present invention in a closed position;

FIG. 2A shows a cross-section of a guide and a part of a longitudinal support;

FIG. 2B shows a perspective schematic view of the outer end of a longitudinal support;

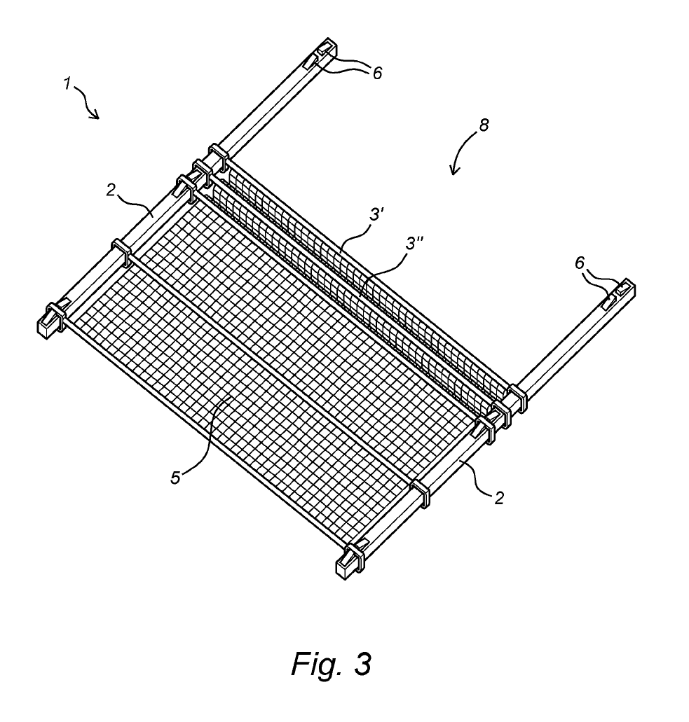

FIG. 3 shows a perspective schematic view of the poultry container cover as shown in FIG. 1 in a partially opened position;

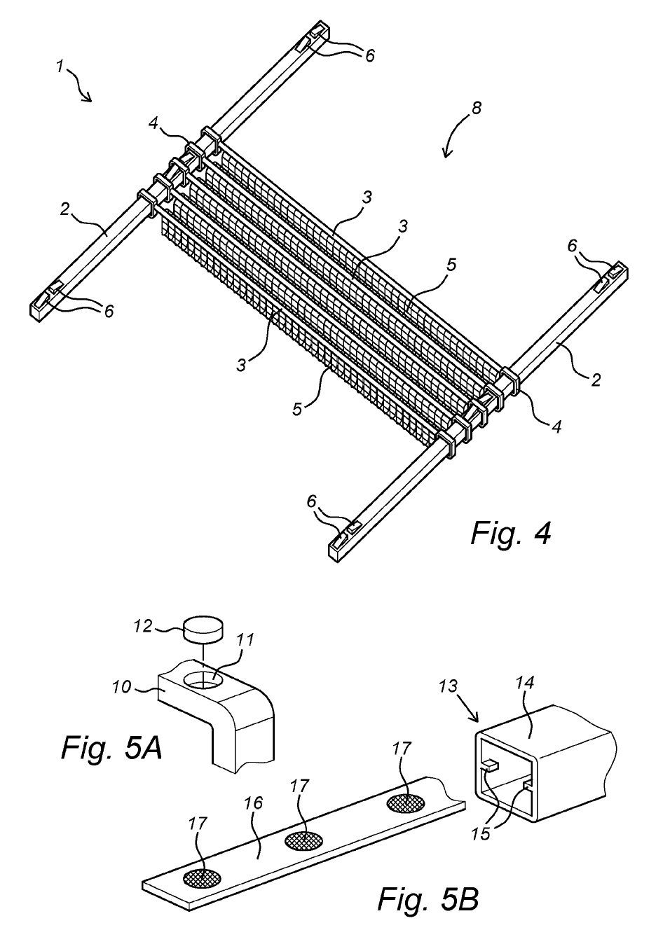

FIG. 4 shows a perspective schematic view of the poultry container cover as shown in FIGS. 1 and 3 in a fully opened position;

FIG. 5A shows a perspective schematic view of an alternative embodiment of the outer end of a longitudinal support and a magnet to be place in this outer end of the longitudinal support;

FIG. 5B shows a perspective view on an end part of a guide and a strip holding magnets to be placed into the guide;

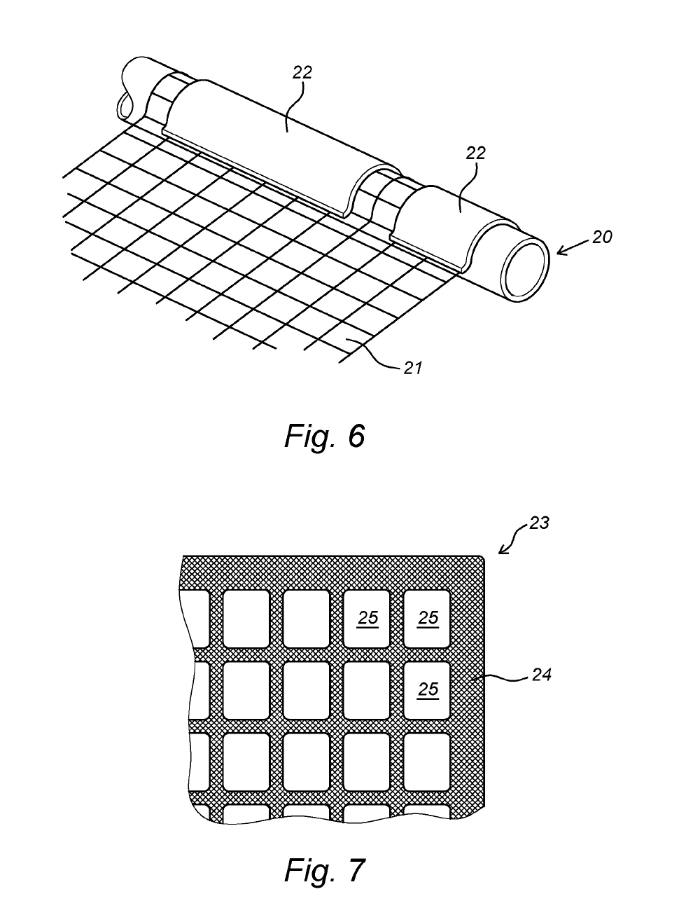

FIG. 6 shows a perspective view on a part of a longitudinal support and a flexible cover sheet clamped onto the longitudinal support;

FIG. 7 shows a top view on an alternative embodiment of a flexible cover sheet;

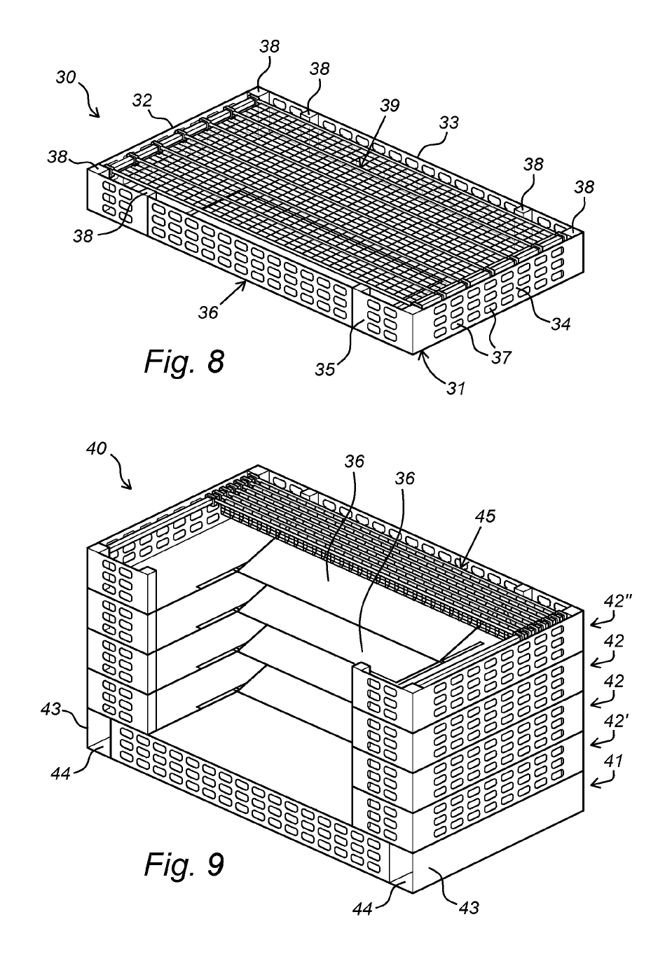

FIG. 8 shows a perspective schematic view of a poultry container including a closed cover according to the present invention; and

FIG. 9 shows a perspective schematic view of a poultry container assembly including a top poultry container with an opened cover according to the present invention.

FIG. 1 shows a poultry container cover 1 with two parallel guides 2, here embodied as bars, along which guides 2 longitudinal supports 3 are slideable. The longitudinal supports 3 comprise on opposite sides two brackets 4 that enclose the guides 2. The longitudinal supports 3 stretch a flexible cover sheet 5, here embodied as a net. As is clearly depicted in FIG. 2A—but also shown in FIG. 1—the guide 2 has bevelled notches 6 that define preferred positions for a brackets 4 that are part of a longitudinal support 3. A bracket 4 is shown in more detail in FIG. 2B. To prevent the bracket 4 coming loose from the guide 2 the bracket 4 has a closed opening 7 to encircle the guide 2.

In FIG. 3 the poultry container cover 1 as shown in FIG. 1 is depicted again, however now in a half opened position. Two of the longitudinal supports 3′ and 3″ are shifted towards the middle of the parallel guides 2 thus creating a space 8 between the guides 2 that is not covered anymore by the cover sheet 5. The poultry container cover 1 in this half opened position provides access to a poultry container when attached to such poultry container. In FIG. 4 the poultry container cover 1 as shown in FIGS. 1 and 3 is shown again but now in a fully opened position wherein all the longitudinal supports 3 are shifted towards the middle of the guides 2. As an alternative the poultry container cover 1 may also be fully opened by moving the longitudinal supports 3 together somewhere else on the guides 2 (thus not in the middle of the guides 2 but for instance on one of the two opposite sides of the guides 2). The flexible cover sheet 5 is in this position of the longitudinal supports 3 not covering the opening (space) between the two guides 2 anymore.

In FIG. 5A a part of a bracket 10 from a longitudinal support is shown including an aperture 11 for holding a magnet 12. Such bracket 10 is preferably to be used in combination with a type of guide 13 as shown in FIG. 5B. This guide 13 is formed by a profile section 14 that has an internal holding structure 15 for a strip 16 holding several magnets 17. The cooperation between the magnet 12 in the bracket 10 with the magnets 17 in the guide 13 define preferred positions of the bracket 10 of a longitudinal support 3 on the guide 13. In the embodiment according to the FIGS. 5A and 5B the bevelled notches 6 as shown in the FIGS. 1, 2A, 3 and 4 are thus superfluous.

FIG. 6 shows a perspective view on a part of a longitudinal support 20 carrying a flexible cover sheet (net) 21. The cover sheet 21 is attached to the longitudinal support 20 using clamping elements 22. In FIG. 7 a top view on an alternative cover sheet 23. Here the cover sheet 23 is a synthetic film 24 wherein spaces 25 are left open.

FIG. 7 shows a poultry container 30 for holding live poultry, with a bottom wall 31 and four side walls 32-35 protruding from the bottom wall 31. A door 36 is formed by a section of one of the side walls 35 and a section of the bottom wall 31. The door 36 is displaceable between a position wherein the door 36 fits the rest of the poultry container 30, which is the situation shown in FIG. 8, and a position wherein the door 36 leaves an opening in the side wall 35 and the bottom wall 31 for the passage of poultry (this situation is shown in FIG. 9). The side walls 32-35 of the poultry container 30 are provided with apertures 37 for aeration/ventilation. Furthermore the poultry container 30 has support columns 38 for carrying the weight of structures that may be stacked onto the poultry container 30. The poultry container 30 is also proved with a poultry container cover 39, here shown in the closed position. For a more detailed description of the poultry container cover 39 reference is made to the previous figures. The poultry container cover 39 may be fully integrated with the poultry container 30, e.g. by welding the guides to the poultry container 30, but as an alternative the poultry container cover 39 may also be releasable attached to the poultry container 30. Releasable attachments are for instance clamping attachments, form fitting attachments, snap fitting attachments, bolted attachments, combinations of such attachments and/or alternative releasable attachments.

FIG. 9 shows a perspective schematic view of a poultry container assembly 40 wherein on a poultry container base 41 subsequently four poultry containers 42 are stacked. The poultry container base 41 holds two parallel sockets 43 wherein openings 44 are provided for handling the poultry container base 41. The doors 36 (see also FIG. 8) of all the poultry containers 42 are in the opened position, for instance to enable the loading of the poultry container base 41 with live poultry. After the poultry container base 41 is loaded the door 36 of the lower poultry container 42′ may be closed (to the position as depicted in FIG. 8). Now the lower poultry container 42′ may be loaded and this procedure may be repeated until all the poultry containers 42 are loaded. After loading all the poultry containers 42, including the top poultry container 42″ a poultry container cover 45 that is part of the top poultry container 42″ may be closed to hold the live poultry loaded in the top poultry container 42″.

1.-14. (canceled)

15. A cover for a poultry container for holding live poultry, comprising:
two substantially parallel guides;
plural longitudinal supports, on opposite sides moveable connected to the guides; and
a flexible cover sheet, connected to the longitudinal supports;
wherein the parallel guides are provided with preferred holding locations for preferred positioning of the longitudinal supports onto the guides.

16. The poultry container cover according to claim 15, wherein the preferred holding locations of the substantially parallel guides are defined with relief on the guides.

17. The poultry container cover according to claim 15, wherein the preferred holding locations of the substantially parallel guides are defined with magnetic force.

18. The poultry container cover according to claim 15, wherein the flexible cover sheet is provided with openings.

19. The poultry container cover according to claim 15, wherein the flexible cover sheet is a net.

20. The poultry container cover according to claim 15, wherein at least one longitudinal support is connected fixed to the guides.

21. The poultry container cover according to claim 15, wherein guides are provided with couplings for connecting the guides onto a poultry container.

22. A poultry container for holding live poultry, comprising:
a bottom wall, four side walls protruding from the bottom wall and a cover for a poultry container according to claim 15, which poultry container cover is connected to the side walls at distance from the bottom wall.

23. The poultry container for holding live poultry according to claim 22, wherein the preferred holding locations are located on the parallel guides at least on positions adjoining two opposite side walls of the poultry container and at one or more positions centrally between two opposite walls.

24. The poultry container for holding live poultry according to claim 22,
wherein the poultry container is provided with a door,
which door is formed by a section of one of the side walls and a, with the side wall section connected, section of the bottom wall,
which door is moveable connected with the rest of the poultry container such that the door is displaceable between a position wherein the door fits the rest of the poultry container and a position wherein the door leaves an opening in the side wall and the bottom for the passage of poultry.

25. The poultry container according to claim 22, wherein the door is centrally located in the side wall wherein the door is installed.

26. The poultry container according to claim 22, wherein the door is slideable connected with the rest of the bottom wall.

27. The poultry container assembly for holding live poultry, comprising plural stacked poultry containers including a poultry container with a poultry container cover according to claim 22 placed on top of the stack of poultry containers.

28. The poultry container assembly according to claim 27, wherein the poultry container assembly includes a poultry container base.
